(19) United States
(12) Patent Application Publication
(10) Pub. No.: US 2002/0117588 A1
(43) Pub. Date: Aug. 29, 2002

(54) Collapsible computer mouse pad

(76) Inventor: Paul F Lando, Red Lion, PA (US)

Correspondence Address: JAMES RAY & ASSOCIATES, 2640 Pitcairn Road, Monroeville, PA, 15146, US

(21) Appl. No.: 10/094,181

(22) Filed: Mar. 8, 2002

Related U.S. Application Data
(62) Division of application No. 29/130,555, filed on Oct. 4, 2000.

(51) Int. Cl. B68G 5/00

(52) U.S. Cl. 248/118; 248/918

(57) ABSTRACT

An ergonomic apparatus for supporting a computer mouse that is connectable with a predetermined member. The apparatus comprises a support tray having a predetermined shape and having a mousing surface disposed on at least a portion of an upper surface of the support tray. There is a mounting assembly which has a first end and a second end. A first means is disposed adjacent the first end of the mounting assembly for engaging the mounting assembly with the support tray in a position which will permit the support tray to rotate to various positions. A locking hinge mechanism is rotatingly engageable with the second end of the mounting assembly. A second means is engageable with the locking hinge mechanism for securing the mounting assembly to an underside of such predetermined member.

### CROSS REFERENCE TO RELATED APPLICATIONS

The invention taught in this patent application is a divisional application of the invention taught in the following co-pending patent application, COMPUTER MOUSE PAD, Ser. No. 29/130,555 which was filed on Oct. 4, 2000. The invention taught in this patent application is also closely related to the invention taught in the following co-pending patent application, COMPUTER MOUSE PAD, Ser. No. ______ which is being filed concurrently herewith. These patent applications are assigned to the same assignee and the teachings therein are incorporated into this application by reference thereto.

### FIELD OF INVENTION

The present invention relates, in general, to an a computer mouse pad and, more particularly, the present invention relates to an ergonomic adjustable mouse pad for use with a computer mouse and which is attachable to a keyboard tray of a computer.

### BACKGROUND OF THE INVENTION

Computer users that operate a computer almost entirely with the use of a mouse can be subjected to the same wrist and hand problems that are encountered by typists and others that use keyboards or other equipment in which the wrist is held in one position for a prolonged period of time. Many instances such activity can lead to carpal tunnel syndrome.

It is generally believed that it is the constant angle at which a wrist is subjected to in order to perform the function results in stresses on the wrist that can in some instances be disabling. Therefore, it would be beneficial if it would be possible to perform the mouse function and also provide relief for the wrist.

### SUMMARY OF THE INVENTION

The present invention provides an ergonomic apparatus for supporting a computer mouse that is connectable with a predetermined member. The apparatus comprises a support tray having a predetermined shape and having a mousing surface disposed on at least a portion of an upper surface of the support tray. There is a mounting assembly which has a first end and a second end. A first means is disposed adjacent the first end of the mounting assembly for engaging the mounting assembly with the support tray in a position which will permit the support tray to rotate to various positions. A locking hinge mechanism is rotatingly engageable with the second end of the mounting assembly and a second means is engageable with the locking hinge mechanism for securing the mounting assembly to an underside of such predetermined member.

In an alternate embodiment of the invention there is provided in combination with at least one of a computer keyboard tray, a shelf and a desk top, the improvement comprises an ergonomic apparatus for supporting a computer mouse, the ergonomic apparatus includes a support tray having a predetermined shape and a mousing surface disposed on at least a first portion of an upper surface of the support tray.

There is further a mounting assembly having a first end and a second end and a first means disposed adjacent the first end of the mounting assembly for connecting the mounting assembly to the support tray in a position which will support the support tray and permit the support tray to rotate to various positions. A locking hinge mechanism is rotatingly connected to the second end of the mounting assembly and a second means is engageable with the locking hinge mechanism for securing the mounting assembly to an underside of such predetermined member.

### OBJECTS OF THE INVENTION

It is, therefore, one of the primary objects of the present invention to provide an ergonomic computer mouse pad with a spherically adjustable tilt.

Another object of the present invention is to provide an ergonomic computer mouse pad with a spherically adjustable tilt that is connectable to a computer keyboard tray.

Still another object of the present invention is to provide an ergonomic computer mouse pad with a spherically adjustable tilt that is connectable to a computer keyboard tray and can be stored under the keyboard tray.

Yet another object of the present invention is provide a means for securing such computer mouse when the ergonomic computer mouse pad is stored under the keyboard tray.

It is also an object of the present invention to provide an ergonomic computer mouse pad that is adaptable for either right or left hand use.

An additional object of the present invention is to provide an ergonomic computer mouse pad can aid in reducing or preventing injury due to repetitive motion.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a plan view of a presently preferred embodiment of the invention.

FIG. 2 is a side elevation view of the embodiment shown in FIG. 1.

FIG. 3 is an end view of the embodiment shown in FIG. 1.

FIG. 4 is a bottom view of the preferred embodiment shown in FIG. 1 with the apparatus in a retracted position under a computer keyboard tray.

FIG. 5 is a side elevation view of the embodiment of the invention shown in FIG. 1 with the apparatus in a retracted position under a computer keyboard tray.

FIG. 6 is an end view of the embodiment of the invention shown in FIG. 1 with the apparatus in a retracted position under a computer keyboard tray.

FIG. 7 is top view of the invention according to an alternate embodiment.

FIG. 8 is a side elevation view of the invention according to the alternate embodiment shown in FIG. 7.

FIG. 9 is a bottom view of the invention according to the alternate embodiment shown in FIG. 7.

### BRIEF DESCRIPTION OF THE INVENTION

Prior to proceeding with the more detailed description of the present invention it should be noted that, for the sake of clarity, identical components which have identical functions have been designated by identical reference numerals throughout the several views illustrated in the drawings.

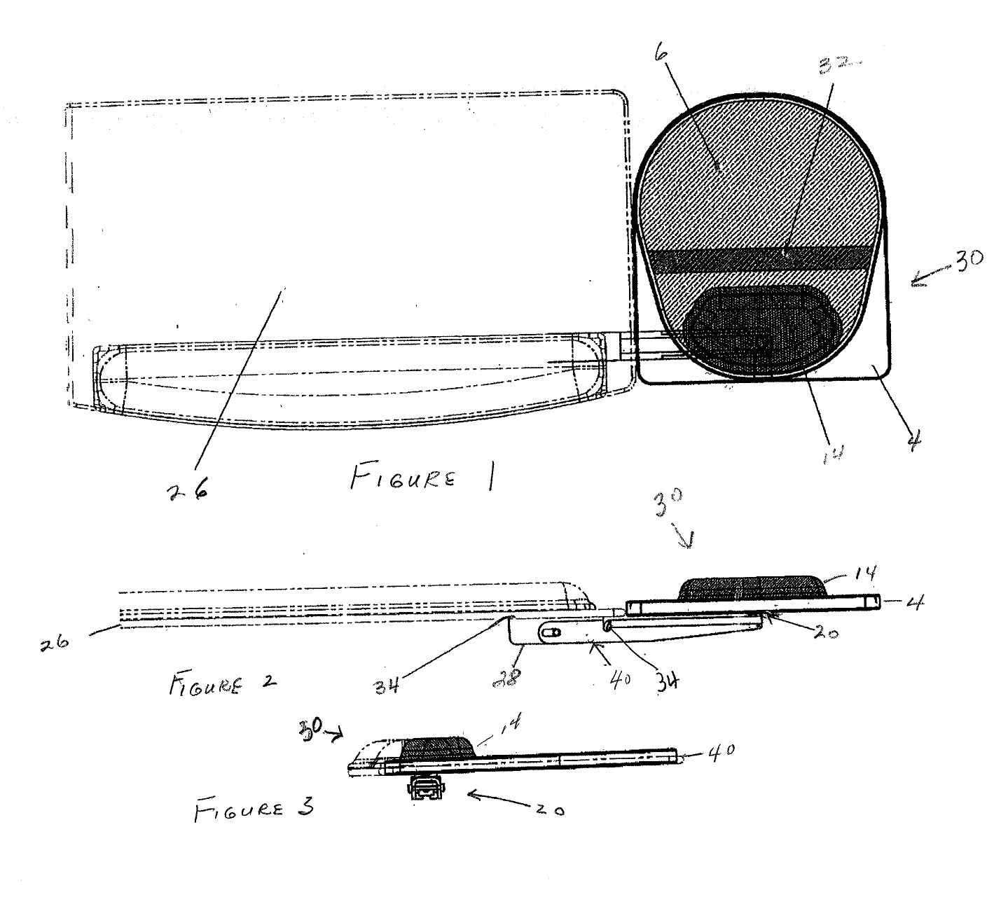

Reference is now made to FIGS. 1 through 6. Illustrated therein is an embodiment of the invention of an apparatus, generally designated 30, for supporting a computer mouse.

The apparatus 30 comprises a support tray 4 having a predetermined shape. Such predetermined shape is generally rectangular. However, such rectangular shape may also have at least one arcuate end. Such shape may be oval or square or any other desired shape. It is presently preferred that there be one arcuate end on such generally rectangular shape. A mousing surface 6 is disposed on at least a portion of the upper surface of the support tray 4.

A mounting assembly, generally designated 40, has a first end 22 and a second end 24. Further, the apparatus includes a first means, generally designated 20, that is disposed adjacent such first end 22 of the mounting assembly 40 for engaging the mounting assembly 40 with the support tray 4 in a position which will permit the support tray 4 to rotate to various positions.

In a presently preferred embodiment of the invention such first means 4 includes a spherical articulated joint 8. Such spherical articulated joint 8 permits such support tray 6 to rotate in any direction and at any angle thus providing infinite variable angles for the support tray 4 to rotate about the base member 2.

The first means 20 further includes a third means 12 for adjusting the resistance on the spherical articulated joint 8. In a presently preferred embodiment of the invention such third means 12 is an Allen screw 12. It is also presently preferred that such Allen screw 12 is engageable with the spherical articulated joint 8 through the mounting assembly 40.

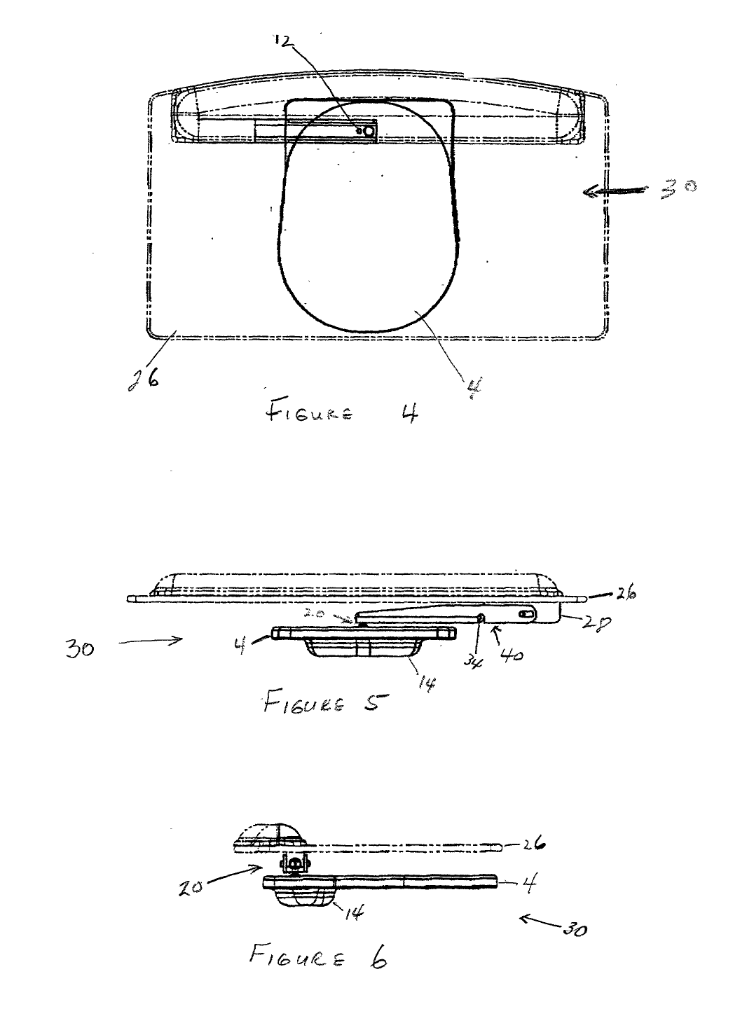

The apparatus 30 further includes a locking hinge mechanism 28 that is rotatingly connected to the second end 24 of such mounting assembly 40. Such locking hinge mechanism 28 permits the apparatus 30 to lock into the position where such apparatus is beside a predetermined member 26 as is seen in FIG. 1 or when the locking hinge mechanism 28 is unlocked and rotated it permits the apparatus 30 to be out of the way and stored in a retracted position under such predetermined member 26 as is evident in FIGS. 4, 5 and 6. Such locking hinge mechanism 28 further includes spring means 34 for providing a bias tension on such rotating portion of such locking hinge mechanism 28. Such predetermined member 26 may be a computer keyboard tray, a shelf or a desktop; however, the most advantageous location is in conjunction with the tray of a computer keyboard.

A second means 34 is engageable with such locking hinge mechanism 28 for securing the mounting assembly 40 to an underside of such computer keyboard tray 28. In an embodiment of the invention such second means 34 is at least one of one an adhesive strip and screws. It is presently preferred that such second means 34 be adhesive strips which permit such locking hinge mechanism 28 to adhere to the underside of such keyboard tray 26. However, such means 34 could also include screws along with such adhesive strips.

In still another embodiment of the invention such support tray 4 further includes a wrist pad 14. It is presently preferred that such wrist pad 14 be mounted on at least a portion of the support tray and be part of such mousing surface 6. Such wrist pad 14 is generally flexible and may be gel filled. In yet another embodiment there is a mouse retaining strap 32 for holding the mouse whenever the apparatus 30 is in a retracted position under the keyboard tray 26. It is presently preferred that such mouse retaining strap 32 is an elastic band.

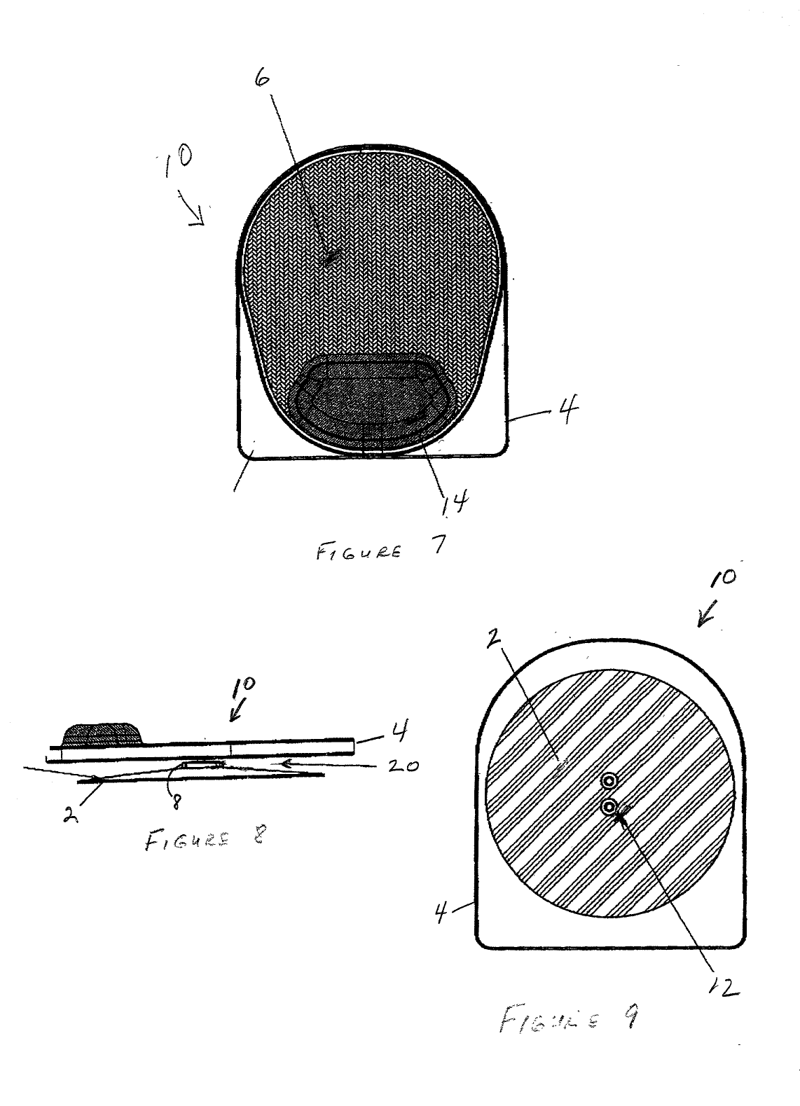

Reference is now made to FIGS. 7-9. Illustrated therein is an alternate embodiment of the invention for an apparatus, generally designated 10, for supporting a computer mouse pad.

The apparatus 10 comprises a base member 2 having a first predetermined shape. In an embodiment of the invention such base member 2 is generally circular and it is generally preferred that the bottom surface of such base member 2 be non skid. Such non skid surface may rubberized material or it may contain at least one suction cup.

The apparatus 10 further has a support tray 4 which has a second predetermined shape. Such second predetermined shape is generally rectangular. However, such rectangular shape may also have at least one arcuate end. Such shape may be oval or square or any other desired shape. It is presently preferred that such shape be generally rectangular with one arcuate end on such generally rectangular shape.

A mousing surface 6 is disposed on the upper surface of such support tray 4. Further, the apparatus includes a means, generally designated 20, engageable with an upper surface of the base member 2 and a bottom surface of the support tray 4 for permitting the support tray 4 to rotate to various positions.

In a presently preferred embodiment of the invention such means 4 includes a spherical articulated joint 8. Such spherical articulated joint 8 permits such support tray 4 to rotate in any direction and at any angle thus providing infinite variable angles for the support tray 4 to rotate about the base member 2.

The means 20 further includes a means for providing a resistance adjustment 12 for the spherical articulated joint 8. In a presently preferred embodiment of the invention such means for providing resistance adjustment 12 is an Allen screw. It is also presently preferred that such Allen screw is engageable with the spherical articulated joint 8 through the base member 2.

In another embodiment of the invention such support tray 4 further includes a wrist pad 14. It is presently preferred that such wrist pad 14 be mounted on at least a portion of the support tray 4 as part of such mousing surface 6. Such wrist pad 14 is generally flexible and may be gel filled.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. An ergonomic apparatus for supporting a computer mouse engageable with a predetermined member, said apparatus comprising:
(a) a support tray having a predetermined shape;
(b) a mousing surface disposed on at least a first portion of an upper surface of said support tray;
(c) a mounting assembly having a first end and a second end;
(d) a first means disposed adjacent said first end of mounting assembly for engaging said mounting assembly with said support tray in a position which will both support said support tray and permit said support tray to rotate to various positions;
(e) a locking hinge mechanism rotatingly connected to said second end of said mounting assembly; and
(f) a second means engageable with said locking hinge mechanism for securing said mounting assembly-to an underside of such predetermined member.

2. An ergonomic apparatus for supporting a computer mouse, according to claim 1, wherein said first means includes a spherical articulated joint.

3. An ergonomic apparatus for supporting a computer mouse, according to claim 2, wherein said spherical articulated joint provides an infinite variable angle for connecting said support tray to said base member.

4. An ergonomic apparatus for supporting a computer mouse, according to claim 2, wherein said spherical articulated joint includes a means for providing a predetermined resistance adjustment for said spherical articulated joint.

5. An ergonomic apparatus for supporting a computer mouse, according to claim 4, wherein said means for providing a predetermined resistance adjustment on said spherical articulated joint is an Allen screw.

6. An ergonomic apparatus for supporting a computer mouse, according to claim 5, wherein said Allen screw is engageable with said spherical articulated joint through said mounting assembly.

7. An ergonomic apparatus for supporting a computer mouse, according to claim 1, wherein said support tray further includes a wrist pad disposed on at least a second portion of said upper surface of said support tray.

8. An ergonomic apparatus for supporting a computer mouse, according to claim 7, wherein said wrist pad is disposed on said mousing surface closely adjacent a first end of said mousing surface.

9. An ergonomic apparatus for supporting a computer mouse, according to claim 7, wherein said wrist pad is flexible.

10. An ergonomic apparatus for supporting a computer mouse, according to claim 7, wherein said wrist pad is gel filled.

11. An ergonomic apparatus for supporting a computer mouse, according to claim 1, wherein said locking hinge mechanism permits said mounting block assembly to rotate said apparatus to a retracted position under such predetermined member.

12. An ergonomic apparatus for supporting a computer mouse, according to claim 1, wherein said second means further includes at least one of an adhesive and screws for mounting said locking hinge mechanism to an underside of such predetermined member.

13. An ergonomic apparatus for supporting a computer mouse, according to claim 12, wherein said second means is an adhesive.

14. An ergonomic apparatus for supporting a computer mouse, according to claim 1, wherein said predetermined shape is generally rectangular.

15. An ergonomic apparatus for supporting a computer mouse, according to claim 1, wherein said support tray further includes a computer mouse retaining strap for holding such computer mouse when said apparatus is in a retracted position under such predetermined member.

16. An ergonomic apparatus for supporting a computer mouse, according to claim 15, wherein said computer mouse retaining strap is an elastic band.

17. An ergonomic apparatus for supporting a computer mouse, according to claim 1, wherein said locking hinge mechanism further includes a spring means.

18. In combination with at least one of a computer keyboard tray, a shelf and a desk top, the improvement comprising an ergonomic apparatus for supporting a computer mouse, said ergonomic apparatus including:
(a) a support tray having a predetermined shape;
(b) a mousing surface disposed on at least a first portion of an upper surface of said support tray;
(c) a mounting assembly having a first end and a second end;
(d) a first means disposed adjacent said first end of mounting assembly for engaging said mounting assembly with said support tray in a position which will support said support tray and permit said support tray to rotate to various positions;
(e) a locking hinge mechanism rotatingly connected to said second end of said mounting assembly; and
(f) a second means engageable with said locking hinge mechanism for securing said mounting assembly to an underside of such predetermined member.

19. The combination, according to claim 18, wherein said first means includes a spherical articulated joint.

20. An ergonomic apparatus for supporting a computer mouse, according to claim 19, wherein said spherical articulated joint includes a means for providing a predetermined resistance adjustment for said spherical articulated joint.
